(19) United States
(12) Patent Application Publication
(10) Pub. No.: US 2021/0291663 A1
(43) Pub. Date: Sep. 23, 2021

(54) BRAKING METHOD AND DRIVETRAIN SYSTEM FOR A VEHICLE

(71) Applicant: ELITE ENERGY CO., LTD., Taichung City (TW)

(72) Inventor: YUEH-HAN LI, TAITUNG COUNTY (TW)

(21) Appl. No.: 17/199,771

(22) Filed: Mar. 12, 2021

(30) Foreign Application Priority Data
Mar. 18, 2020 (TW) 109109025

(51) Int. Cl. B60L 7/00; B60L 15/08; B60L 15/20

(52) U.S. Cl. CPC B60L 7/003; B60L 2220/46; B60L 15/2009; B60L 15/08

(57) ABSTRACT

A braking method is provided for a vehicle that includes a wheel, a driving unit, a switching unit and a control unit. The driving unit includes a three-phase motor for driving the wheel to rotate, and three electric cables electrically connected to the three-phase motor. The switching unit is electrically connected between the driving unit and a power source. The braking method includes steps of the control unit controlling the switch unit to establish a short circuit between at least two of the electrical cables, and the three-phase motor producing an internal resistance force because of the short circuit so as to prevent the wheel from rotating.

### CROSS-REFERENCE TO RELATED APPLICATION

This application claims priority to Taiwanese Invention Patent Application No. 109109025, filed on Mar. 18, 2020.

### FIELD

The disclosure relates to a braking method and a drivetrain system for a vehicle, and more particularly to a braking method and a drivetrain system for keeping a vehicle securely motionless when the vehicle is stationary.

### BACKGROUND

A conventional braking method for keeping an electric vehicle securely motionless (especially on a sloped surface) is to control an electric motor of the electric vehicle to output a continuous force to counteract rotation of one or more wheels of the electric vehicle. The continuous force will oppose gravitational force and prevent the electric vehicle from sliding down the sloped surface.

However, in the conventional braking method, the output of the continuous force from the electric motor must be continuous for the vehicle to remain stationary. Therefore, the electric motor will output a large amount of power when the electric vehicle is parked, which will in turn drain battery charge from the electric vehicle, and thereby decrease the range of the electric vehicle.

### SUMMARY

Therefore, an object of the disclosure is to provide a braking method and a drivetrain system that can alleviate at least one of the drawbacks of the prior art.

According to one aspect of the disclosure, a braking method is provided for a vehicle that includes a wheel, a driving unit, an electric power source, a switching unit and a control unit. The driving unit includes a three-phase motor coupled to the wheel for driving the wheel to rotate, and three electrical cables electrically connected to the three-phase motor. The electric power source has a positive electrode and a negative electrode. The switching unit includes three first switches each electrically connected between the positive electrode and a respective one of the electrical cables, and three second switches each electrically connected between the negative electrode and a respective one of the electrical cables. The control unit is electrically connected to the first and second switches, and is configured to control operation of each of the first and second switches.

The braking method includes steps of: the control unit operating in a parking mode upon receiving a parking signal; in the parking mode, the control unit controlling operations of the first and second switches to establish a short circuit between at least two of the electrical cables; and the three-phase motor producing an internal resistance force because of the short circuit so as to prevent the wheel from rotating.

According to another aspect of the disclosure, a drivetrain system is provided for a vehicle that includes a wheel. The drivetrain system includes a driving unit that includes a three-phase motor coupled to the wheel for driving the wheel to rotate, and three electrical cables electrically connected to the three-phase motor. The drivetrain system further includes an electric power source that has a positive electrode and a negative electrode. The drivetrain system further includes a switching unit that includes three first switches each electrically connected between the positive electrode and a respective one of the electrical cables, and three second switches each electrically connected between the negative electrode and a respective one of the electrical cables. Additionally, the drivetrain system further includes a control unit that is electrically connected to the first and second switches and that is configured to control operations of the first and second switches to establish a short circuit between at least two of the electrical cables, so that the three-phase motor produces an internal resistance force because of the short circuit so as to prevent the wheel from rotating.

### BRIEF DESCRIPTION OF THE DRAWINGS

Other features and advantages of the disclosure will become apparent in the following detailed description of the embodiment(s) with reference to the accompanying drawings, of which:

FIG. 1 is a block diagram illustrating a drivetrain system according to an embodiment of this disclosure;

FIG. 2 is a circuit diagram illustrating the drivetrain system according to an embodiment of this disclosure;

FIG. 3 is a flow chart of a braking method for a vehicle according to an embodiment of this disclosure;

FIG. 4 is a circuit diagram illustrating a switching unit of the drivetrain system operating in a first mode; and

FIG. 5 is a circuit diagram illustrating the switching unit of the drivetrain system operating in a second mode.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

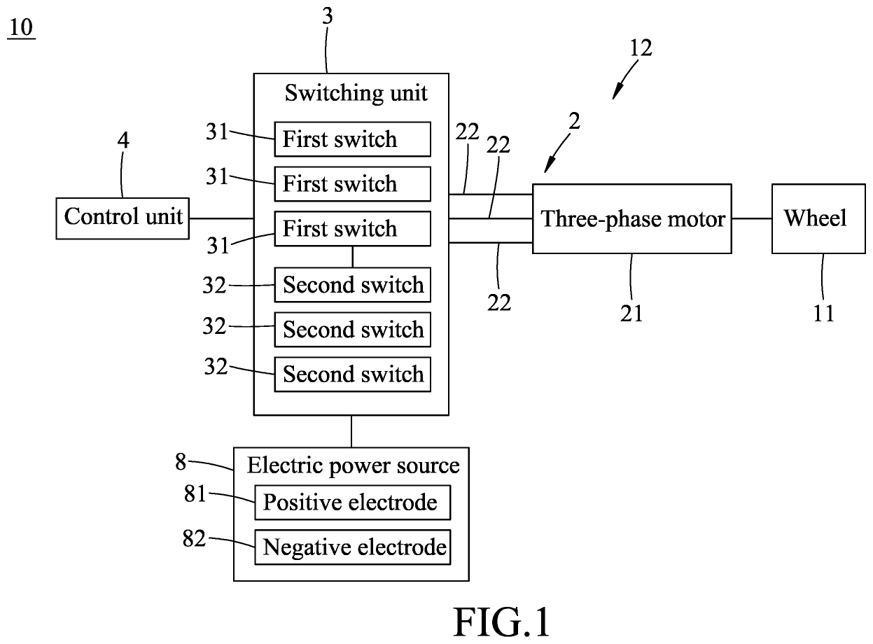

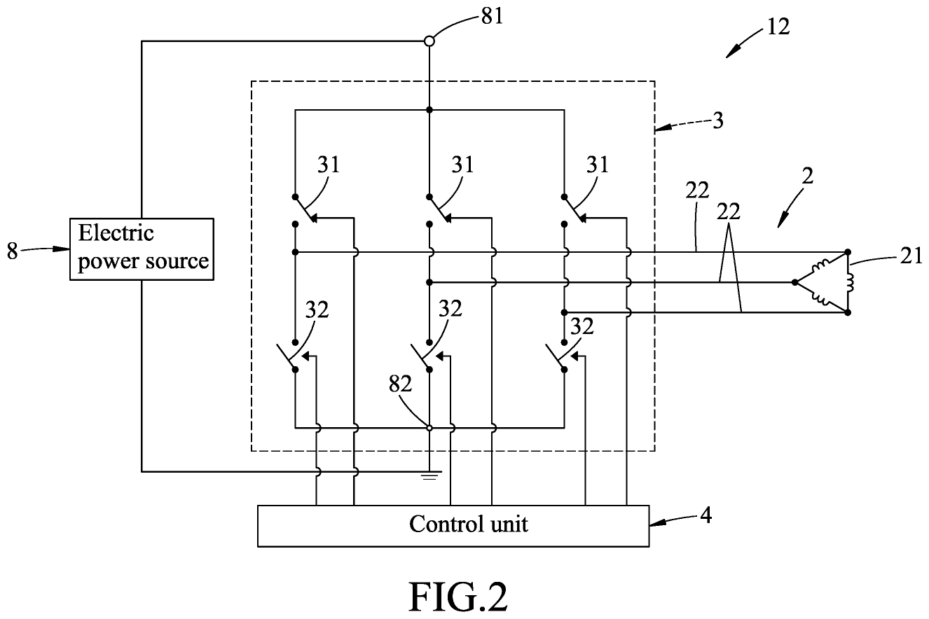

Referring to FIGS. 1 and 2, an embodiment of a drivetrain system 12 for application of a braking method is shown. The braking method is applied to the drivetrain system 12 for a vehicle 10. Specifically, the braking method is for keeping the vehicle 10 securely motionless when the vehicle 10 is stationary. The vehicle 10 includes a wheel 11 and the drivetrain system 12. The drivetrain system 12 includes a driving unit 2, an electric power source 8, a switching unit 3 and a control unit 4.

The driving unit 2 includes a three-phase motor 21 coupled to the wheel 11 for driving the wheel 11 to rotate, and three electrical cables 22 electrically connected to the three-phase motor 21.

The electric power source 8 is, for example, a battery pack, solar panels, fuel cells, etc., and has a positive electrode 81 and a negative electrode 82. The switching unit 3 includes three first switches 31 each electrically connected between the positive electrode 81 and a respective one of the electrical cables 22, and three second switches 32 each electrically connected between the negative electrode 82 and a respective one of the electrical cables 22. In some embodiments, the negative electrode 82 is grounded.

The control unit 4 is electrically connected to the first and second switches 31, 32, and is configured to control operations of the first and the second switches 31, 32 to establish a short circuit between at least two of the electrical cables 22, so that the three-phase motor 21 produces an internal resistance force because of the short circuit. The internal resistance force produced by the three-phase motor 21 will prevent the wheel 11 from rotating. For example, the control unit 4 is a microcontroller including, but not limited to, a single core processor, a multi-core processor, a dual-core mobile processor, a microprocessor, a microcontroller, a digital signal processor (DSP), a field-programmable gate array (FPGA), an application specific integrated circuit (ASIC), and/or a radio-frequency integrated circuit (RFIC), etc.

It should be noted that the internal resistance force produced by the three-phase motor 21 as a result of the short circuit between two of the electrical cables 22 is an inherent property of the three-phase motor 21, and the principle and details thereof will be omitted hereinafter for the sake of brevity. The internal resistance force may prevent a rotor (not shown) of the three-phase motor 21 from rotating, and therefore also prevent the wheel 11 from rotating.

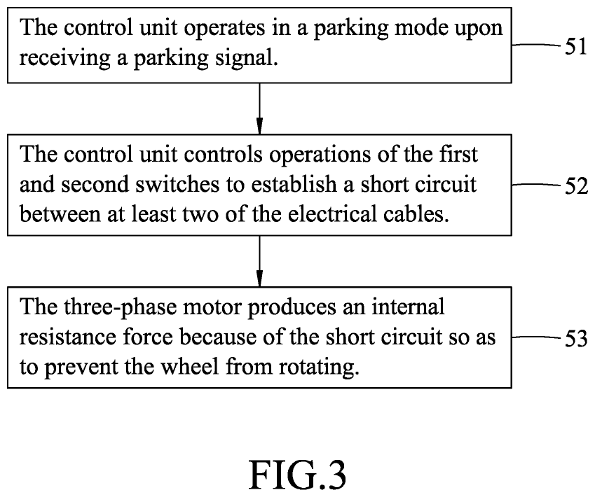

Further referring to FIG. 3, the braking method to be implemented by the drivetrain system 12 includes the following steps 51-53

In step 51, the control unit 4 operates in a parking mode upon receiving a parking signal. In some embodiments, the control unit 4 is activated to operate in the parking mode when a parking switch (not shown) is triggered by a driver of the vehicle 10 to send the parking signal to the control unit 4.

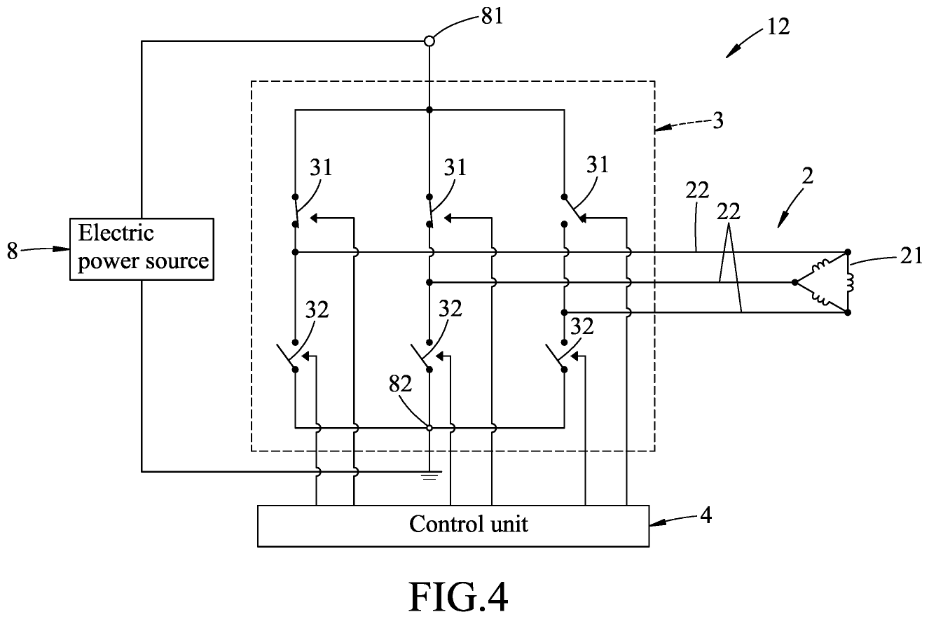

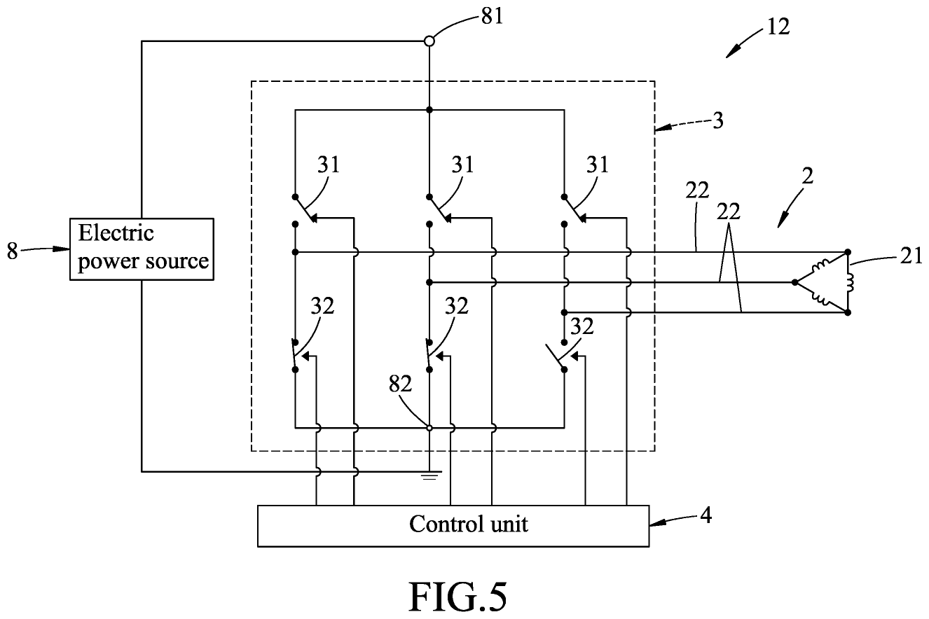

In step 52, in the parking mode, the control unit 4 controls the switching unit 3 to operate in one of a first mode (see FIG. 4) and a second mode (see FIG. 5). One of ordinary skill in the art would appreciate that the control unit 4 of the drivetrain system 12 according to one embodiment of this disclosure may be designed to control the switching unit 3 to operate in the first mode when in the parking mode, while the control unit 4 of the drivetrain system 12 according to another embodiment of this disclosure may be designed to control the switching unit 3 to operate in the second mode when in the parking mode, or alternatively, be designed to control the switching unit 3 to selectively operate in the first or second mode when in the parking mode. When the switching unit 3 operates in any one of the first mode and the second mode, the first and second switches 31, 32 cooperatively establish a short circuit between at least two of the electrical cables 22.

In the first mode, at least two of the first switches 31 are turned on and the second switches 32 are all turned off, so that a short circuit is established between at least two of the electrical cables 22 that are electrically connected to the at least two of the first switches 31 that are turned on. FIG. 4 illustrates an example where the switching unit 3 operates in the first mode; in this example, the control unit 4 turns on only two of the first switches 31 thereby shorting two of the electrical cables 22, but in other embodiments, all of the first switches 31 may be turned on, thereby establishing short circuits among all of the electrical cables 22.

In the second mode, the first switches 31 are all turned off and at least two of the second switches 32 are turned on, so that a short circuit is established between at least two of the electrical cables 22 that are electrically connected to the at least two of the second switches 32 that are turned on. FIG. 5 illustrates an example where the switching unit 3 operates in the second mode; in this example, the control unit 4 turns on only two of the second switches 32 thereby shorting two of the electrical cables 22, but in other embodiments, all of the second switches may be turned on, thereby establishing short circuits among all of the electrical cables 22.

In the present embodiment, the control unit 4 may include a pulse width modulation (PWM) controller configured to output PWM signals to the first and second switches 31, 32, thereby controlling the operations of the first and second switches 31, 32. However, the disclosure is not limited to using the PWM controller to control operation of the first and second switches 31, 32. Instead, the control 4 unit may directly control operation of the first and second switches 31, 32, namely, directly controlling the first switches 31 and the second switches 32 to turn on or turn off.

In step 53, the three-phase motor 21 produces the internal resistance force when the short circuit between the two of the electrical cables 22 is established, so as to prevent the wheel 11 from rotating.

When the driver parks the vehicle 10 on a slope and operates the parking switch to send the parking signal to the control unit 4, the control unit 4 operates in the parking mode and controls the switching unit 3 to operate in the first mode or the second mode, which will establish a short circuit between at least two of the electrical cables 22. The three-phase motor 21 will then produce an internal resistance force that will act on the wheel 11 and prevent the vehicle 10 from sliding down the slope, thereby keeping the vehicle 10 stationary.

The drivetrain system 12 implementing the braking method according to various embodiments of this disclosure only consumes a relatively low amount of electrical energy to control the first switches 31 and the second switches 32 in order to keep the vehicle 10 motionless. Since the short circuit, which causes the three-phase motor 21 to produce the internal resistance force, is created within a closed loop of the switching unit 4 and the three-phase motor 21, it does not drain electrical energy from the electric power source 8. In comparison to a conventional electric vehicle where a continuous force needs to be applied by the motor to prevent a wheel from rotating, the drivetrain system 12 according to various embodiments of the present disclosure has greatly reduced power consumption, thereby increasing the range of the vehicle 10 (i.e., battery life of the electric power source 8 for the same amount of charge stored therein).

It should be noted that while only one wheel 11 is disclosed in the above-mentioned embodiment(s), the drivetrain system 12 may be used to implement the braking method for preventing multiple wheels from rotating.

In summary, by controlling the first switches 31 and the second switches 32 to establish a short circuit between at least two of the electric cables 22, the three-phase motor 21 produces an internal resistance force and prevents the wheel 11 from rotating. Through the application of the braking method, a large amount of energy may be saved when the vehicle 10 is parked.

In the description above, for the purposes of explanation, numerous specific details have been set forth in order to provide a thorough understanding of the embodiment (s) . It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A braking method for a vehicle that includes a wheel, a driving unit, an electric power source, a switching unit and a control unit, the driving unit including a three-phase motor coupled to the wheel for driving the wheel to rotate, and three electrical cables electrically connected to the three-phase motor, the electric power source having a positive electrode and a negative electrode, the switching unit including three first switches each electrically connected between the positive electrode and a respective one of the electrical cables, and three second switches each electrically connected between the negative electrode and a respective one of the electrical cables, the control unit being electrically connected to the first and second switches and configured to control operation of each of the first and second switches, the braking method comprising steps of:
the control unit operating in a parking mode upon receiving a parking signal;
in the parking mode, the control unit controlling operations of the first and second switches to establish a short circuit between at least two of the electrical cables; and
the three-phase motor producing an internal resistance force because of the short circuit so as to prevent the wheel from rotating.

2. The braking method as claimed in claim 1, wherein the step of controlling operations of the first and second switches to establish a short circuit between at least two of the electrical cables includes controlling the switching unit to operate in one of a first mode and a second mode.

3. The braking method as claimed in claim 2, wherein, in the first mode, at least two of the first switches are turned on and the second switches are all turned off, so that a short circuit is established between at least two of the electrical cables that are electrically connected to the at least two of the first switches.

4. The braking method as claimed in claim 2, wherein, in the second mode, the first switches are all turned off and at least two of the second switches are turned on, so that a short circuit is established between at least two of the electrical cables that are electrically connected to the at least two of the second switches.

5. The braking method as claimed in claim 1, wherein, in the step of controlling operations of the first and second switches to establish a short circuit between at least two of the electrical cables, the control unit controls the first and second switches by outputting pulse width modulation signals to the first and second switches.

6. A drivetrain system for a vehicle that includes a wheel, comprising:
a driving unit including a three-phase motor adapted to be coupled to the wheel for driving the wheel to rotate, and three electrical cables electrically connected to said three-phase motor;
an electric power source having a positive electrode and a negative electrode;
a switching unit including three first switches each electrically connected between said positive electrode and a respective one of said electrical cables, and three second switches each electrically connected between said negative electrode and a respective one of said electrical cables; and
a control unit electrically connected to said first and second switches and configured to control operations of said first and second switches to establish a short circuit between at least two of said electrical cables, so that said three-phase motor produces an internal resistance force because of the short circuit so as to prevent the wheel from rotating.

7. The drivetrain system as claimed in claim 6, wherein said control unit is configured to control said switching unit to operate in one of a first mode and a second mode to establish a short circuit between at least two of said electrical cables.

8. The drivetrain system as claimed in claim 7, wherein, in the first mode, at least two of said first switches are turned on and said second switches are all turned off, so that a short circuit is established between at least two of said electrical cables that are electrically connected to the at least two of said first switches.

9. The drivetrain system as claimed in claim 7, wherein, in the second mode, said first switches are all turned off and at least two of said second switches are turned on, so that a short circuit is established between at least two of said electrical cables that are electrically connected to the at least two of said second switches.

10. The drivetrain system as claimed in claim 6, wherein said control unit is a pulse width modulation (PWM) controller configured to output PWM signals to said first and second switches so as to control operations of said first and second switches.
